(19) United States
(12) Patent Application Publication
(10) Pub. No.: US 2018/0254868 A1
(43) Pub. Date: Sep. 6, 2018

(54) USER TERMINAL, RADIO BASE STATION, AND RADIO COMMUNICATION METHOD

(71) Applicant: NTT DOCOMO, INC., Tokyo (JP)

(72) Inventors: Keisuke Saito, Tokyo (JP); Hiroki Harada, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 15/779,457

(22) PCT Filed: Nov. 25, 2016
(86) PCT No.: PCT/JP2016/084915

§ 371 Date: May 25, 2018

(30) Foreign Application Priority Data
Nov. 27, 2015 (JP) 2015-231950

(51) Int. Cl. H04L 5/00; H04W 72/04

(52) U.S. Cl. CPC H04L 5/0048; H04W 72/0406

(57) ABSTRACT

A user terminal is disclosed that carries out communication using a predetermined radio access scheme. The user terminal includes a receiver that receives a reference signal in a specified radio resource, and carries out a reception process on the reference signal based on a specified orthogonalization application range, and a processor that determines at least one of the specified radio resource and the specified orthogonalization application range based on communication parameters used in the predetermined radio access scheme. A base station is also disclosed including a transmitter that applies orthogonalization to a reference signal based on a specified orthogonalization application range, and transmits the reference signal in a specified radio resource, and a processor that determines at least one of the specified radio resource and the specified orthogonalization application range based on communication parameters used in the predetermined radio access scheme.

### CROSS REFERENCE TO RELATED APPLICATIONS

The present application is a national phase application of PCT/JP2016/084915 filed on Nov. 25, 2016, which claims priority to Japanese Patent Application No. 2014-219734, filed on Oct. 28, 2014. The contents of these applications are incorporated by reference in their entirety.

### FIELD OF THE INVENTION

The present invention relates to a user terminal, a radio base station and a radio communication method in a next-generation mobile communication system.

### BACKGROUND

In a Universal Mobile Telecommunications System (UMTS) network, long-term evolution (LTE) has been standardized for the purpose of further increasing high-speed data rates and providing low delay, etc. See non-patent literature 1. For the purpose of achieving further broadbandization and higher speeds relative to LTE (also referred to as LTE Rel. 8 or 9), LTE-A (which is also referred to as LTE-Advanced, LTE Rel. 10, 11 or 12) has been formally specified, and successor systems (also referred to as, e.g., Future Radio Access (FRA), 5^{th} Generation Mobile Communication System (5G), LTE Rel. 13, Rel. 14, etc.) also have been studied.

In LTE Rel. 10/11, in order to achieve further broadbandization, carrier aggregation (CA) which integrates a plurality of component carriers (CCs) is implemented. Each CC is configured as a unit of the LTE Rel. 8 system bandwidth. Furthermore, in CA, a plurality of CCs of the same radio base station (eNB: eNodeB) are configured in the user terminal (UE: User Equipment).

In LTE Rel. 12, dual connectivity (DC) is also implemented, in which a plurality of cell groups (CG) of different radio base stations are configured in the UE. Each cell group is configured of at least one cell (CC). In DC, since a plurality of CCs of different radio base stations are combined, DC is also referred to as inter-base station CA (Inter-eNB CA).

Furthermore, LTE Rel. 8 through 12 implements frequency division duplex (FDD) which carries out downlink (DL) transmission and uplink (UL) transmission on different frequencies, and time division duplex (TDD) which periodically switches between downlink transmission and uplink transmission in the same frequency.

### CITATION LIST

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”.

### SUMMARY OF INVENTION

In accordance with one or more embodiments of the invention, a user terminal is described that carries out communication using a predetermined radio access scheme, the user terminal comprising: a receiver that receives a reference signal in a specified radio resource, and carries out a reception process on the reference signal based on a specified orthogonalization application range; and a processor that determines at least one of the specified radio resource and the specified orthogonalization application range based on communication parameters used in the predetermined radio access scheme.

In some aspects, the communication parameters include at least one of a sub-carrier spacing, a carrier frequency, a number of symbols configuring a predetermined radio resource region, and a number of sub-carriers configuring a predetermined radio resource region.

In some aspects, the processor determines the specified orthogonalization application range based on the communication parameters and on a number of layers configured in the user terminal.

In some aspects, compared to a reference signal configuration of an existing LTE system, the specified radio resource has a same number of resource elements in the time direction and has a same number of resource elements in the frequency direction.

In some aspects, when compared to a reference signal configuration of an existing LTE system, the specified radio resource is different with regard to at least one of a number of resource elements in the time direction and a number of resource elements in the frequency direction.

In some aspects, the user terminal is configured with at least a first layer and a second layer, and the receiver uses a code length in the first layer that is different from a code length in the second layer to carry out the reception process of the reference signal.

In some aspects, the receiver, within a predetermined radio resource region, carries out the reception process while considering at least one code element of an orthogonal code, applied to the reference signal, that overlaps at least one reference signal resource element of the specified radio resource.

According to one or more embodiments of the invention, a user terminal is disclosed that carries out communication using a predetermined radio access scheme, the user terminal comprising: a transmitter that applies orthogonalization to a reference signal based on a specified orthogonalization application range, and transmits the reference signal in a specified radio resource; and a processor that determines at least one of the specified radio resource and the specified orthogonalization application range based on communication parameters used in the predetermined radio access scheme.

According to one or more embodiments of the invention, a radio base station is described that carries out communication with a user terminal using a predetermined radio access scheme, the radio base station comprising: a transmitter that applies orthogonalization to a reference signal based on a specified orthogonalization application range, and transmits the reference signal in a specified radio resource; and a processor that determines at least one of the specified radio resource and the specified orthogonalization application range based on communication parameters used in the predetermined radio access scheme.

According to one or more embodiments of the invention, a radio communication method is described that uses a predetermined radio access scheme, the radio communication method comprising: receiving a reference signal in a specified radio resource, and carrying out a reception process on the reference signal based on a specified orthogonalization application range; and determining at least one of the specified radio resource and the specified orthogonalization application range based on communication parameters used in the predetermined radio access scheme.

### BRIEF DESCRIPTION OF DRAWINGS

FIG. 1 is an illustrated diagram of a LTE RAT subframe configuration and a New RAT subframe configuration.

FIGS. 2A through 2C are illustrative diagrams of DMRS configurations in transmission mode 9 of an existing LTE system.

FIGS. 3A through 3E show reference signal configurations and orthogonalization application ranges pertaining to a first example in accordance with embodiments of the present invention.

FIGS. 4A through 4E show reference signal configurations and orthogonalization application ranges pertaining to a second example in accordance with embodiments of the present invention.

FIGS. 5A through 5E show reference signal configurations and orthogonalization application ranges pertaining to a third example in accordance with embodiments of the present invention.

FIGS. 6A through 6E show reference signal configurations and orthogonalization application ranges pertaining to a fourth example in accordance with embodiments of the present invention.

FIGS. 7A through 7E show reference signal configurations and orthogonalization application ranges pertaining to a fifth example in accordance with embodiments of the present invention.

FIGS. 8A through 8E show reference signal configurations and orthogonalization application ranges pertaining to a sixth example in accordance with embodiments of the present invention.

FIG. 9 is an illustrative diagram of a schematic configuration of a radio communication system in accordance with embodiments of the present invention.

FIG. 10 is an illustrative diagram showing an overall configuration of a radio base station in accordance with embodiments of the present invention.

FIG. 11 is an illustrative diagram of a functional configuration of the radio base station in accordance with embodiments of the present invention.

FIG. 12 is an illustrative diagram showing an overall configuration of a user terminal in accordance with embodiments of the present invention.

FIG. 13 is an illustrative diagram showing a functional configuration of the user terminal in accordance with embodiments of the present invention.

FIG. 14 is an illustrative diagram showing a hardware configuration for a radio base station and a user terminal in accordance with embodiments of the present invention.

### DETAILED DESCRIPTION

In future radio communication systems (e.g., 5G), in order to meet the demands of ultra-high speed, higher volume and ultra-low latency, etc., utilization of a broadband frequency spectrum is being studied. Furthermore, in future radio communication systems, there is a demand to cope with an environment in which a vast number of devices are simultaneously connected to a network.

For example, it is envisaged that future radio communication systems will carry out communication in a high frequency band (e.g., a band of several scores of GHz) which can easily ensure a broadband, and will carry out communication for use in Internet of Things (IoT), Machine Type Communication (MTC), Machine To Machine (M2M), etc., which use a relatively small communication amount.

In order to satisfy the above-described demands, a new access scheme (New Radio Access Technology (New RAT)) design that is suitable for high frequency bands is being studied. However, in the case where a radio communication scheme used in an existing radio communication system (e.g., LTE Rel. 8 through 12) is simply applied to New RAT, the communication quality deteriorates and there is a risk of not being able to carry out communication adequately.

Embodiments of the present invention have been devised in view of the above discussion. Embodiments of the invention provide a user terminal, a radio base station and a radio communication method that can achieve adequate communication in a next-generation communication system.

In accordance with embodiments of the invention, a user terminal is provided, which carries out communication using a predetermined radio access scheme and includes a receiving section configured to receive a reference signal in a specified radio resource, and to carry out a reception process on the reference signal based on a specified orthogonalization application range; and a control section configured to decide the specified radio resource and/or the specified orthogonalization application range based on communication parameters used in the predetermined radio access scheme.

According to embodiments of the present invention, adequate communication in a next-generation communication system can be achieved.

An enhanced access scheme of an access scheme used in an existing LTE/LTE-A system (which may be referred to as LTE RAT) is being studied for use as an access scheme in a future new communication system (which may be referred to as New RAT, 5G RAT, etc.).

In New RAT, a radio frame and/or subframe configuration that are different to those of LTE RAT may be used. For example, a radio frame configuration of New RAT can have a radio frame configuration that is different compared to an existing LTE (LTE Rel. 8 through 12) with regard to at least one of a transmission time interval (TTI) length, symbol length, sub-carrier spacing, and bandwidth.

More specifically, in New RAT, a method is being studied which uses parameters (e.g., sub-carrier spacing, bandwidth, symbol length, etc.), that configure an LTE radio frame multiplied by a constant factor (e.g., multiplied by N, or multiplied by 1/N) based on LTE RAT numerology. “Numerology” refers to a signal design in RAT, or a parameter set that characterizes the RAT design.

It is conceivable for New RAT to support a plurality of numerologies, having different symbol lengths and sub-carrier spacing, etc., in accordance with required conditions for each type of usage, and to coexist within New RAT. Note that a New RAT cell may be allocated to overlap the coverage of an LTE RAT cell, or may be independently allocated.

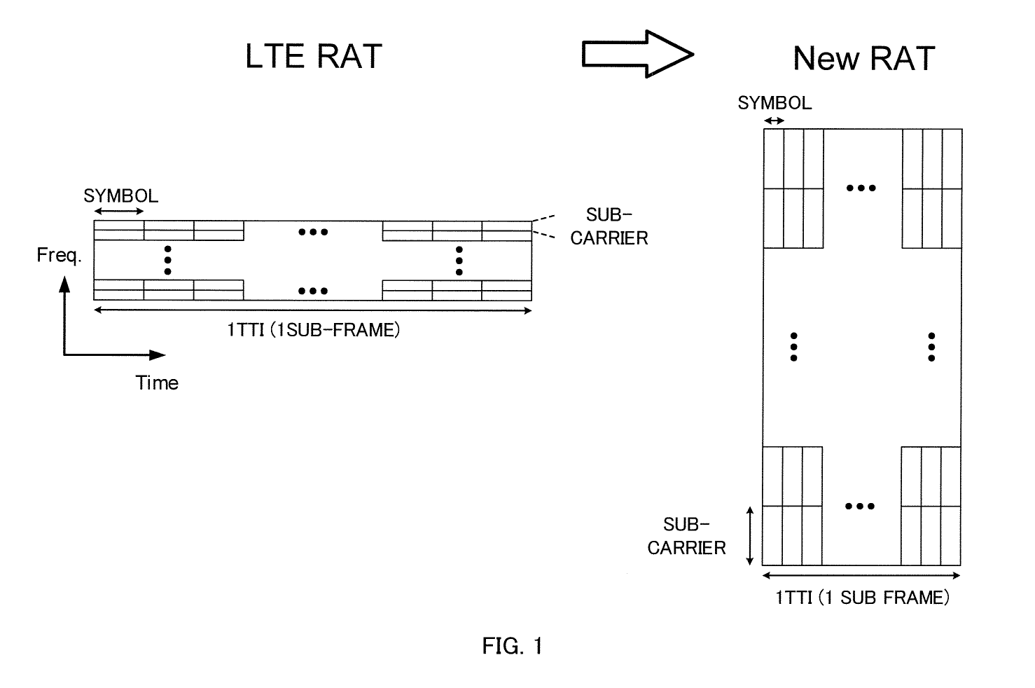

An example of numerology employed in New RAT would be a configuration in which, in New RAT, the sub-carrier spacing and the bandwidth can be multiplied by a factor of N (e.g., N>1) and the symbol length can be multiplied by a factor of 1/N, based on LTE RAT. FIG. 1 is an illustrated diagram of a LTE RAT subframe configuration and a New RAT subframe configuration.

In FIG. 1, New RAT has a subframe configuration (TTI configuration) in which the sub-carrier spacing is large and the symbol length is short compared to LTE RAT. By shortening the TTI length, control processing delays can be reduced, so that latency time can be shortened. Note that a TTI that is shorter than the TTI used in LTE (e.g., a TTI that is less than 1 ms) may be referred to as a shortened TTI.

According to the configuration shown in FIG. 1, because the TTI length can be shortened, the time it takes for transmission and reception can be shortened, so that low latency becomes easier to achieve. Furthermore, by enlarging the sub-carrier spacing compared to existing LTE, the influence of phase noise in a high frequency band can be reduced. Accordingly, a high frequency band (e.g., a band of several scores of GHz), which can easily ensure a broadband width, can be implemented in New RAT, and can be favorably implemented in, e.g., high-speed communication using Massive MIMO that utilizes a very large number of antenna elements.

Furthermore, as another example of numerology, a configuration is also conceivable in which the sub-carrier spacing and the bandwidth are multiplied by a factor of 1/N, and the symbol lengths are multiplied by a factor of N. Due to such a configuration, because the entire lengths of the symbols increase, even in a case where the proportion of the Cyclic Prefix (CP) length, which occupies the entire length of the symbols, is constant, the CP length can be lengthened. Accordingly, a stronger (more robust) radio communication with respect to a phasing communication path becomes possible.

However, in New RAT, although a shortened TTI like that shown in FIG. 1 is being studied, it is envisaged that the demand requirements for mobile speeds of the UE will also increase, so that there is a possibility of the need for support of a high-speed mobile environment in a high frequency band.

However, in a case where a radio communication scheme used in an existing radio communication system (e.g., LTE Rel. 8 through 12) is simply applied to New RAT, the communication quality deteriorates and there is a risk of not being able to carry out communication adequately. For example, a demodulation reference signal (DMRS) used in LTE transmission mode (TM) 9 employs a code multiplexing configuration that applies orthogonal code (OCC: Orthogonal Cover Code) in the time direction to a plurality of layers of signals allocated in the same time/frequency resource. However, if such a configuration is simply applied to New RAT, the channel estimation precision may deteriorate in an environment where the time selectivity is high.

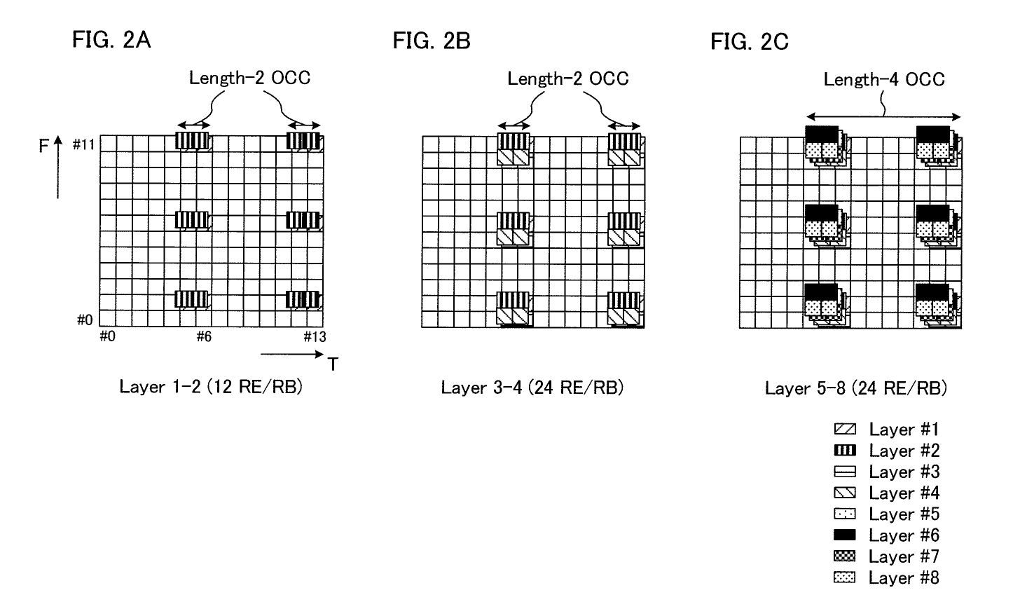

FIG. 2 shows illustrative diagrams of DMRS configurations in transmission mode 9 of an existing LTE system. FIG. 2A shows the case of 1-2 layers, FIG. 2B shows the case of 3-4 layers, and FIG. 2C shows the case of 5-8 layers. FIG. 2 shows 1 resource block (RB) pair of an existing LTE that configured from 1 ms (14 Orthogonal Frequency Division Multiplexing (OFDM) symbols) and 180 kHz (12 sub-carriers).

Note that a resource block pair may be referred to as a physical resource block (PRB: Physical RB) pair, an RB or a PRB, etc. (hereinafter, simply indicated as “RB”). Furthermore, a radio resource region configured by a frequency width of one sub-carrier and an interval of one OFDM symbol is referred to as a resource element (RE).

In each configuration shown in FIG. 2, a DMRS is allocated in symbol #5 and #6 (last two symbols) of each slot. Specifically, with respect to the last two symbols of each slot, a DMRS is allocated in three REs in FIG. 2A (i.e., 12 REs per one RB), and a DMRS is allocated in six REs (i.e., 24 REs per one RB) in FIGS. 2B and 2C. In other words, a DMRS per each layer is allocated in 4 symbols×3 sub-carriers within one RB (number of allocation REs=12).

In FIG. 2, layer #1 through #8 respectively correspond to signals transmitted using antenna ports 7 through 14. In FIGS. 2A and 2B, because two DMRSs are multiplexed per one RE, OCCs having a code length of 2 are multiplied with each DMRS in the time direction. For example, the eNB multiplies [+1, +1] with the DMRS sequence of layer #1, which maps to symbol #5 and #6, and multiplies [+1, −1] with the DMRS sequence of layer #2.

In FIG. 2C, because four DMRSs are multiplexed per one RE, OCCs having a code length of 4 are multiplied with each DMRS in the time direction. For example, the eNB multiplies respectively different OCCs, having a code length of 4, with a DMRS sequence of layer #1 through #4, which map to symbol #5 and #6 of the first slot and map to symbol #5 and #6 of the second slot.

In the orthogonalization in the time direction, as shown in FIG. 2, there is a possibility of deterioration of precision of the channel estimation in an environment having a high time selectivity. In other words, there is a possibility that an orthogonalization method of an existing LTE RAT may be unsuitable in shortened TTIs and a high-speed mobile environment used in New RAT. However, in LTE RAT, a fixed setting that does not depend on the carrier frequency is used in the scope of application of OCCs, used in a reference signal configuration and in a reference signal.

Hence, embodiments of the present invention consider the possibility of a plurality of numerologies (communication parameters) being supported in New RAT, unlike in an existing LTE RAT. One or more embodiments of the invention involve a realization that, depending on the numerology, an existing reference signal configuration (a configuration including a reference signal in 4 symbols×3 sub-carriers within one RB, as in FIG. 2) can be too excessive or insufficient for achieving a desired channel estimation precision.

Furthermore, with regard to a reference signal for use in New RAT, embodiments of the present invention consider how to appropriately set an orthogonalization application range, when code multiplexing a reference configuration and a reference signal, based on New RAT numerology. According to one or more embodiments of the present invention, deterioration of channel estimation precision and an increase in overhead by the reference signal can be suppressed, so that adequate communication can be carried out.

A reference signal configuration refers to, e.g., a radio resource location (resource matching pattern) to which a reference signal is allocated, or a configuration that prescribes an orthogonalization method, etc., that is applied to a reference signal. Furthermore, the orthogonalization application range indicates whether orthogonalization is applied in the time direction, is applied in the frequency direction, or is applied in both directions (time and frequency directions) with respect to a reference signal that is allocated to a plurality of REs. For example, in the case where OCCs are used in orthogonalization, if the orthogonalization application range is “time direction”, an OCC is multiplied with the reference signal, which is allocated in a plurality of REs, in the time direction.

Hereinbelow, detailed descriptions of exemplary embodiments of the present invention will be given with reference to the drawings. Note that in each following embodiment, explanations are given with regard to a demodulation reference signal (e.g., a DMRS) being the reference signal, however, the present invention can be applied to other reference signals. For example, the present invention may be applied to an existing reference signal such as a channel state information reference signal (CSI-RS), or a newly prescribed reference signal.

Furthermore, although the orthogonalization of reference signals is implemented using OCCs, the present invention is not limited thereto. For example, as an orthogonalization method, cyclic shift may be used, OCCs and cyclic shift may be both used, or another orthogonalization method may be used. The orthogonalization application range may be referred to as orthogonalization scope, OCC application scope, or cyclic-shift application scope, etc.

(Radio Communication Method)

### First Embodiment

In a first embodiment of the present invention, the UE renews a reference signal configuration and/or orthogonalization application range based on communication parameters used in a predetermined radio access scheme (e.g., New RAT).

Specifically, the UE may uniquely decide (determine) a reference signal configuration and/or orthogonalization application range in accordance with sub-carrier spacing used in reference-signal allocation, usage frequency (e.g., carrier frequency (central frequency)), the number of symbols that configure a minimum control unit (e.g., one RB, which is a scheduling unit) and/or the number of sub-carriers that configure a minimum control unit, etc. The UE may determine to use a different orthogonalization application range, even if the reference signal configuration is the same, in accordance with the number of layers (number of antenna ports) that are applied (set) to its own terminal. In addition to the communication parameters, the UE may determine the reference signal configuration and/or orthogonalization application range based on the mobile speed of its own terminal and the channel state, etc., between itself and the eNB. Note that the eNB can determine the reference signal configuration and/or orthogonalization application range in the same manner.

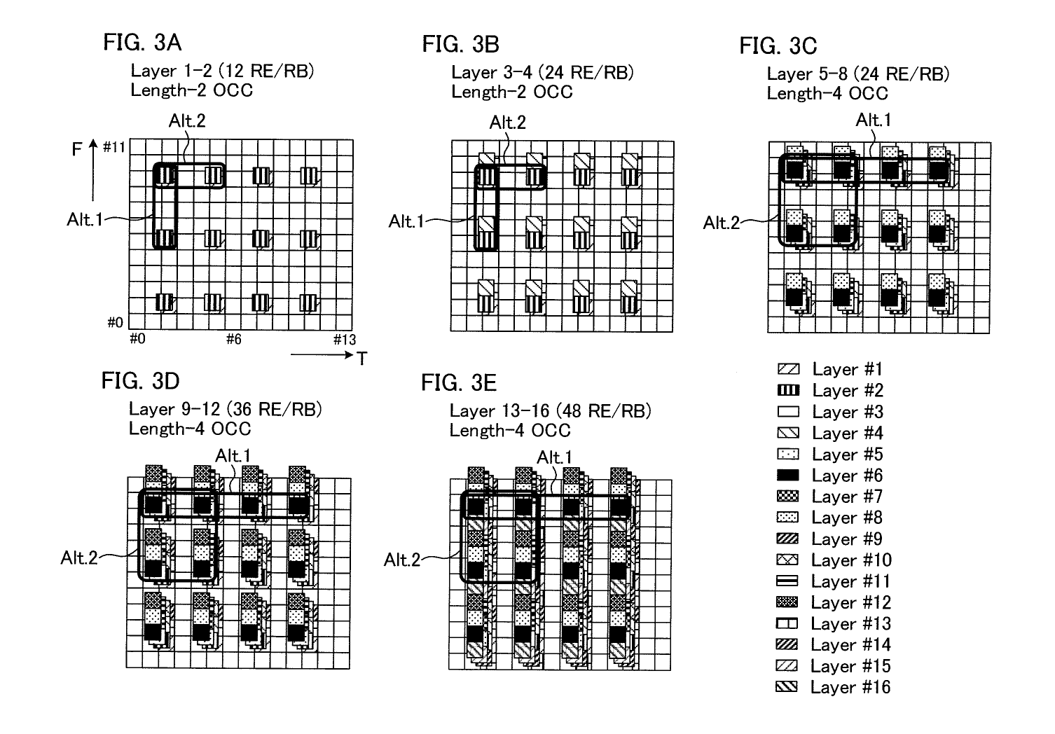

A detailed explanation will be given in regard to a first embodiment of a reference signal configuration and orthogonalization application range that the UE can utilize, with reference to FIGS. 3 through 8. Each example also provides a configuration for up to 16 layers that can be utilized in a future radio communication system, in addition to a configuration for 8 or less layers that has been used in an existing LTE.

Furthermore, in each figure, an example of an assumed orthogonalization application range is indicated as “Alt. (Alternative) x”.

### FIRST EXAMPLE

FIG. 3 shows reference signal configurations and orthogonalization application ranges pertaining to a first example of an embodiment of the present invention. The reference signal resource allocation in FIG. 3 is configured to have the same number of REs in the time direction as the number of REs in the frequency direction within one RB, with respect to the same number of layers, compared to the existing DMRS configuration shown in FIG. 2. Furthermore, the number of REs of the reference signal is 36 per one RB in FIG. 3D (9-12 layers) and is 48 per one RB in FIG. 3E (13-16 layers).

Next, an explanation of the orthogonalization application range will be given. FIG. 3A indicates, using an OCC having a code length of 2, orthogonalization in the frequency direction as an Alt. 1, and orthogonalization in the time direction as an Alt. 2. In the case of FIG. 3, the reference signal per layer is allocated in 4 symbols×sub-carriers (allocated number of REs=12) within one RB. Therefore, in Alt. 2, an OCC only needs to be applied in units of two symbols within a slot.

Whereas, in Alt. 1, the configuration can apply an OCC to one of the sub-carriers with another of the two sub-carriers within one symbol interval. For example, an OCC can be applied to a combination of (symbol #2, sub-carrier #1) and (symbol #2, sub-carrier #5), or an OCC can be applied to a combination of (symbol #2, sub-carrier #9) and (symbol #2, sub-carrier #5).

In such a case, it is desirable for the same code element to be multiplied in these two OCC combinations with respect to (symbol #2, sub-carrier #9). For example, in layer #2, [+1, −1] can be multiplied with the combination of (symbol #2, sub-carrier #1) and (symbol #2, sub-carrier #5), in that order, and [+1, −1] can be multiplied with the combination of (symbol #2, sub-carrier #9) and (symbol #2, sub-carrier #5), in that order.

Accordingly, in the case where the number of REs of a reference signal in the direction of the orthogonalization application range (time direction and/or frequency direction) is not equal to a multiple of the code length of the applied OCC, at least one of the code elements of the OCC may overlap at least one of the REs in the direction of the orthogonalization application range.

FIG. 3B, similar to FIG. 3A, indicates orthogonalization in the frequency direction as Alt. 1, and orthogonalization in the time direction as Alt. 2. Note that in the subsequent figures also, with regard to the OCC having a code length of 2, Alt. 1 indicates orthogonalization in the frequency direction, and Alt. 2 indicates orthogonalization in the time direction.

FIGS. 3C through 3E indicate orthogonalization in the time direction as Alt. 1, and indicate orthogonalization in the time and frequency directions as Alt. 2. Note that in the subsequent figures, unless otherwise indicated, with regard to the OCC having a code length of 4, Alt. 1 indicates orthogonalization in the time direction, and Alt. 2 indicates orthogonalization in the time and frequency directions.

According to the above-described first example, unlike DMRS allocation of an existing system, because each RE of the reference signal is allocated away from each other in a time direction (distributed RE allocation), in an environment in which periodical channel selectivity is low, favorable suppression of deterioration in channel estimation precision can be expected.

### SECOND EXAMPLE

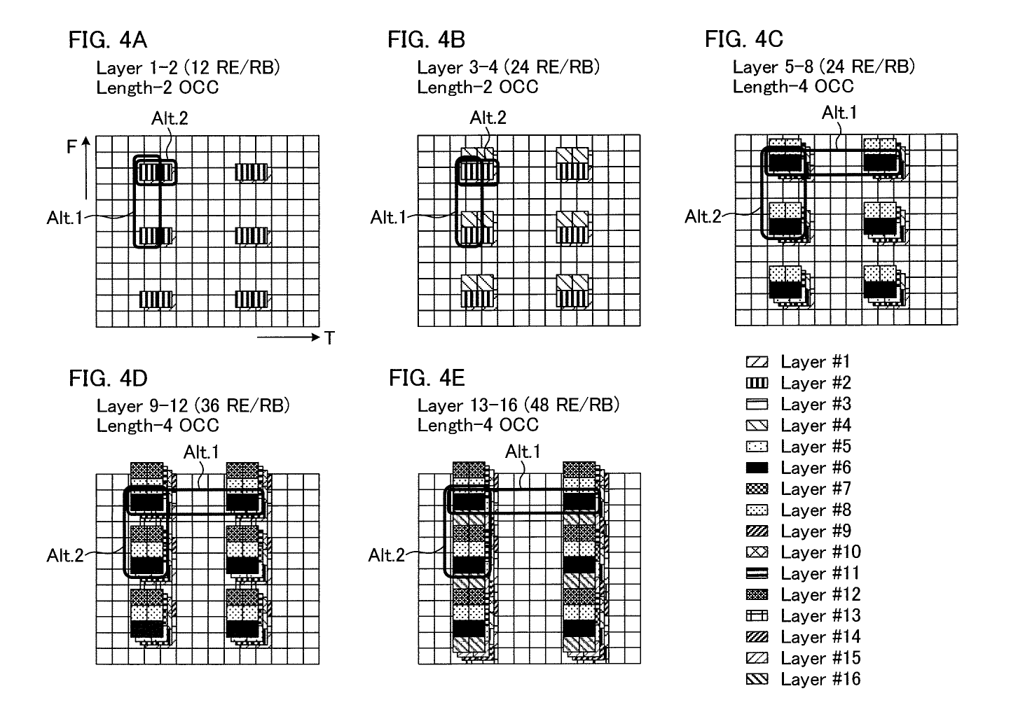

FIG. 4 shows reference signal configurations and orthogonalization application ranges pertaining to a second example of an embodiment of the present invention. The reference signal resource allocation in FIG. 4 is configured to have the same number of REs in the time direction as the number of REs in the frequency direction, with respect to the same number of layers, compared to the existing DMRS configuration shown in FIG. 2. FIG. 4 corresponds to the configuration of FIG. 3, in which REs of a reference signal are allocated in twos, adjacent to each other in the time direction. Since the remaining features may be the same as the reference signal configuration of the first example, description thereof is herein omitted.

According to the above-described second example, because the REs are allocated in a concentrated manner (concentrated RE allocation) in the time direction, in an environment in which periodical channel selectivity is high, favorable suppression of deterioration in channel estimation precision can be expected.

### THIRD EXAMPLE

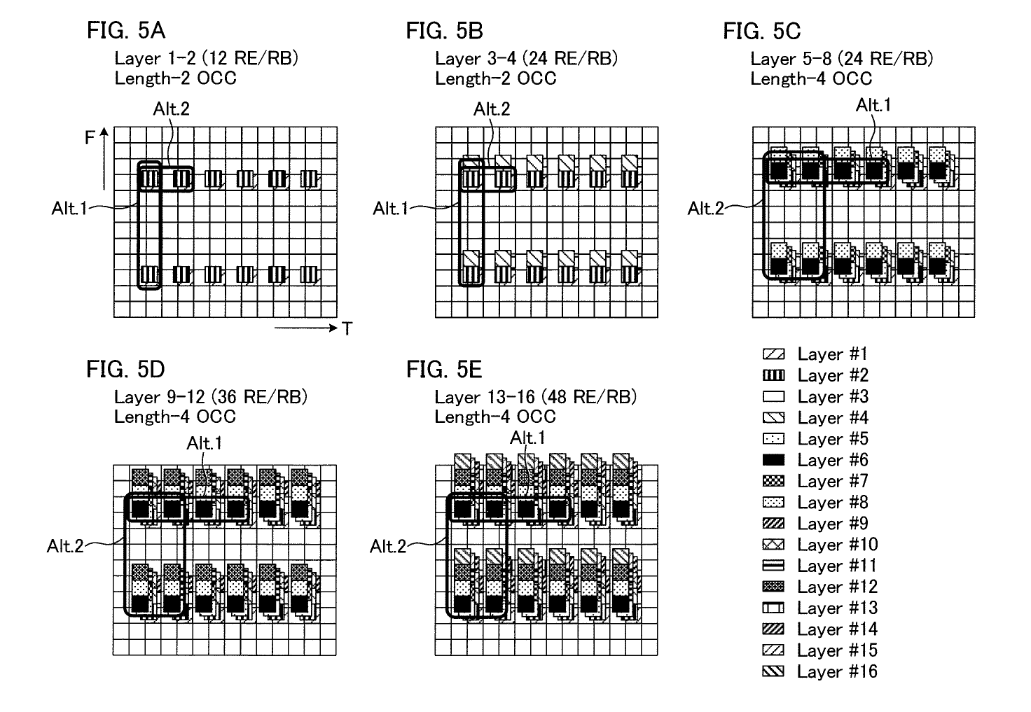

FIG. 5 shows reference signal configurations and orthogonalization application ranges pertaining to a third example of an embodiment of the present invention. The reference signal resource allocation in FIG. 5 is configured to have a greater number of REs (six REs) in the time direction and to have a smaller number of REs (two REs) in the frequency direction, with respect to the same number of layers, compared to the existing DMRS configuration shown in FIG. 2. Note that the number of REs of the reference signals per one RB, with respect to the same number of layers, is the same (=12) as the number of REs in an existing DMRS configuration.

In Alt. 1 of FIGS. 5C through 5E, the number of REs (=6) of the reference signal in the direction (time) of the orthogonalization application range does not equal the multiple of the applied OCC code length (=4). As described with regard to FIG. 3, at least one of the code elements of the OCC may overlap at least one of the REs in the direction of the orthogonalization application range.

According to the above-described third example, because the number of REs in the time direction are greater than the existing reference signal configuration, an improvement in the followability of time selectivity can be expected. Note that the configurations of FIG. 5 can be combined with the concentrated RE allocation configurations shown in FIG. 4. For example, in at least some of the layers, the REs of the reference signals of FIG. 5 may be allocated adjacent to each other in twos (or in threes) in the time direction. Accordingly, it can be expected that a trade-off between concentrated allocation and distributed allocation can be achieved.

### FOURTH EXAMPLE

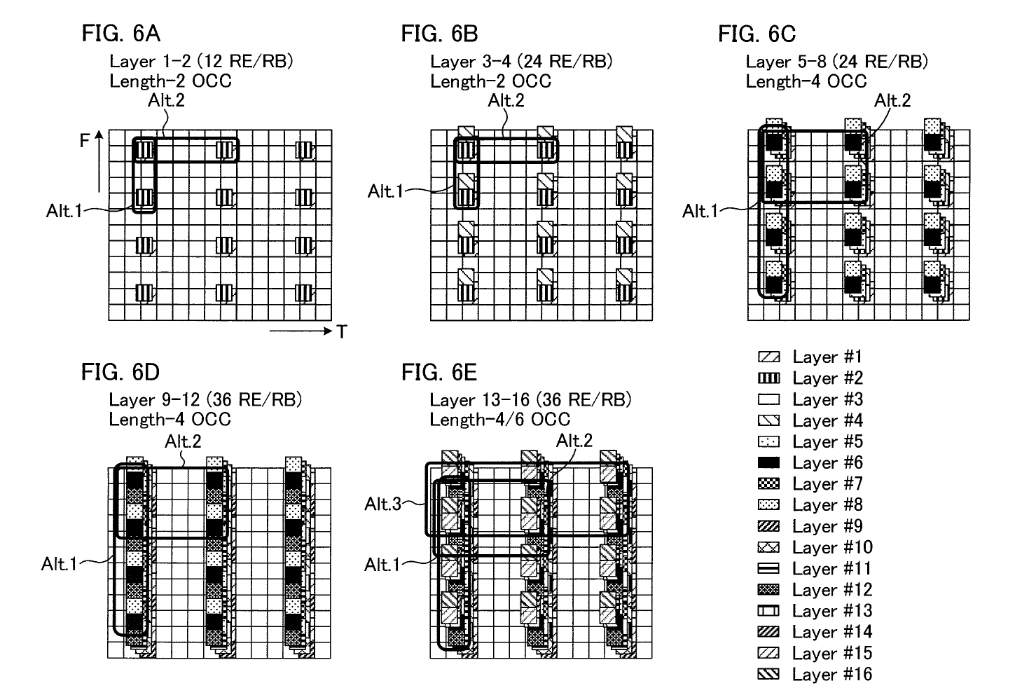

FIG. 6 shows reference signal configurations and orthogonalization application ranges pertaining to a fourth example of an embodiment of the present invention. In the resource allocation of the reference signals of FIG. 6, with respect to the same number of layers, the number of REs (three REs) in the time direction is less than the existing DMRS configuration shown in FIG. 2, and the number of REs (four REs) in the frequency direction is greater. Note that, with respect to the same number of layers, the number of REs of the DMRS per one RB are configured to be the same number of REs (=12) as an existing DMRS configuration.

Unlike the above-described configurations, in the configuration having 13 through 16 layers of FIG. 6E, the REs of four multiplexed reference signals and the REs of six multiplexed reference signals are employed in a configuration that is included in one RB. An OCC having a code length of 4 is applied to the former REs and an OCC having a code length of 6 is applied to the latter REs. Accordingly, a larger number of layers of reference signals can be allocated without increasing the time/frequency resources that the reference signal uses.

In FIG. 6E, an example of an orthogonalization application range having a code length of 4 is expressed by Alt. 1 indicating orthogonalization in the frequency direction and by Alt. 2 indicating orthogonalization in the time and frequency directions. Furthermore, an example of an orthogonalization application range having a code length of 6 is expressed by Alt. 3 indicating orthogonalization in the time and frequency directions. For example, in FIG. 6E, the orthogonalization application range of layer #12 is Alt. 1 or Alt. 2, and the orthogonalization application range of layer #15 is Alt. 3.

Furthermore, in the case where a plurality of code lengths are utilized in this manner, the orthogonalization application range at each code length may be configured differently, or may be configured to be the same.

In Alt. 2 of FIGS. 6C through 6E, the number of REs (=3) of the reference signal in one of the directions (the time direction) of the orthogonalization application range is not the same as the multiple of the code length (=4) of the applied OCC (or a divisor (=2) of the code length of other than 1). In the same manner described with regard to FIG. 3, at least one of the code elements of the OCC may overlap at least one of the REs in the direction of the orthogonalization application range (e.g., (symbol #7, sub-carrier #7) and (symbol #7, sub-carrier #10)).

According to the above-described fourth example, because the number of REs in the frequency direction is greater than that of the existing reference signal configuration, an improvement in the followability of the frequency selectivity can be expected.

Note that the configurations of FIG. 6 can be combined with the concentrated RE allocation configurations shown in FIG. 4. For example, in at least some of the layers, the REs of the reference signals of FIG. 6 may be allocated adjacent to each other in twos (or in threes) in the time direction. Furthermore, in at least some of the layers, the REs of the reference signals of FIG. 6 may be allocated adjacent to each other by a plural number (e.g., by twos) in the frequency direction. Accordingly, it can be expected that a trade-off between concentrated allocation and distributed allocation can be achieved.

### FIFTH EXAMPLE

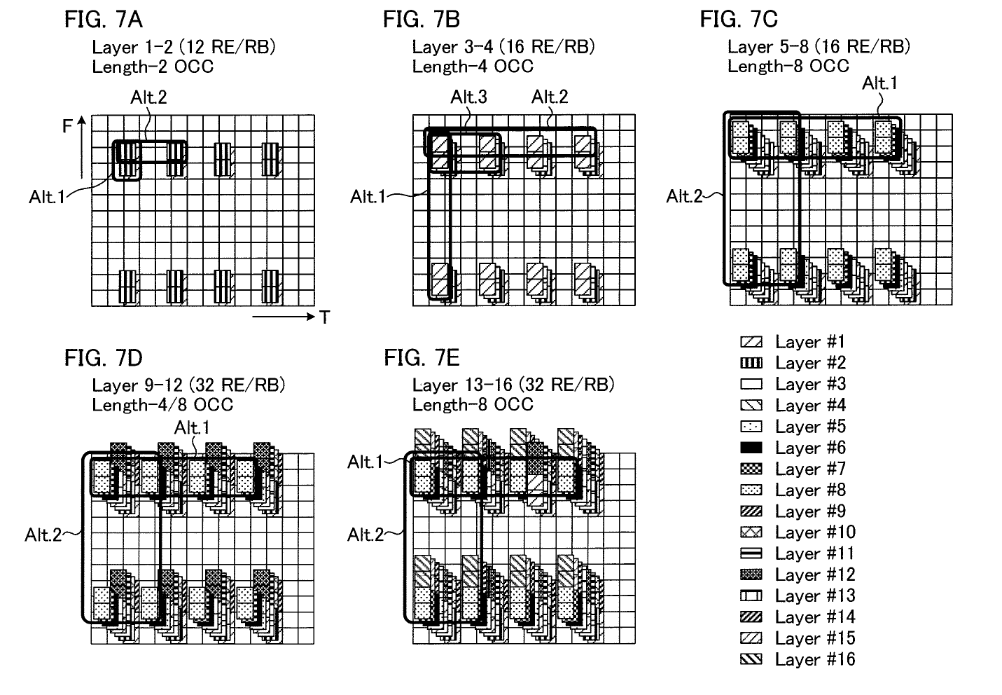

In a fifth example of an embodiment of the present invention, the number of REs (number of allocation REs) of the reference signals per one RB, with respect to the same number of layers, is greater than the number of REs in an existing DMRS configuration. FIG. 7 shows reference signal configurations and orthogonalization application ranges pertaining to a fifth example of the present invention. In the resource allocation of the reference signals of FIG. 7, with respect to the same number of layers, the number of REs (four REs) in the time direction is the same as that of the existing DMRS configuration shown in FIG. 2 and the number of REs (four REs) in the frequency direction is greater. In this case, the number of allocation REs for the reference signal is 16.

In the present example, because the number of REs in the time direction and the number of REs in the frequency direction are the same, it is possible to control the orthogonalization application range in a more flexible manner. In particular, in the case where the number of REs in the time direction, the number of REs in the frequency direction and the OCC code length are all the same, as shown in FIG. 7B, configurations are possible in which the REs of the reference signals of each layer correspond to the OCC in a 1:1 manner which regard to any of: orthogonalization in only the frequency direction (Alt. 1), orthogonalization in only the time direction (Alt. 2), and orthogonalization in the time and frequency directions (Alt. 3).

Furthermore, unlike the above-described configurations, in the configuration having 9 through 12 layers of FIG. 7D, the REs of four multiplexed reference signals and the REs of eight multiplexed reference signals are employed a configuration that is included in one RB. An OCC having a code length of 4 is applied to the former REs and an OCC having a code length of 8 is applied to the latter REs. In FIG. 7D, only orthogonalization application ranges (Alt. 1 and Alt. 2) with OCCs having a code length of 8 are shown for simplicity; however, e.g., in regard to an OCC having a code length 4 used in layer #12, at least one out of the three orthogonalization application ranges that are shown in FIG. 7B can be utilized.

According to the above-described fifth example, because the number of allocated REs per layer is greater than that of an existing reference signal configuration, an improvement in channel estimation precision can be expected. Furthermore, because the code length can be increased and the number of layer multiplexing can be increased, the overhead for the reference signals can be reduced.

Note that the configuration of FIG. 7 can be combined with the concentrated RE allocation configurations shown in FIG. 4. For example, in at least some of the layers, the REs of the reference signals of FIG. 7 may be allocated adjacent to each other by a plural number (e.g., by twos) in the time direction. Furthermore, in at least some of the layers, the REs of the reference signals of FIG. 7 may be allocated adjacent to each other by a plural number (e.g., by fours) in the frequency direction. Accordingly, it can be expected that a trade-off between concentrated allocation and distributed allocation can be achieved.

### SIXTH EXAMPLE

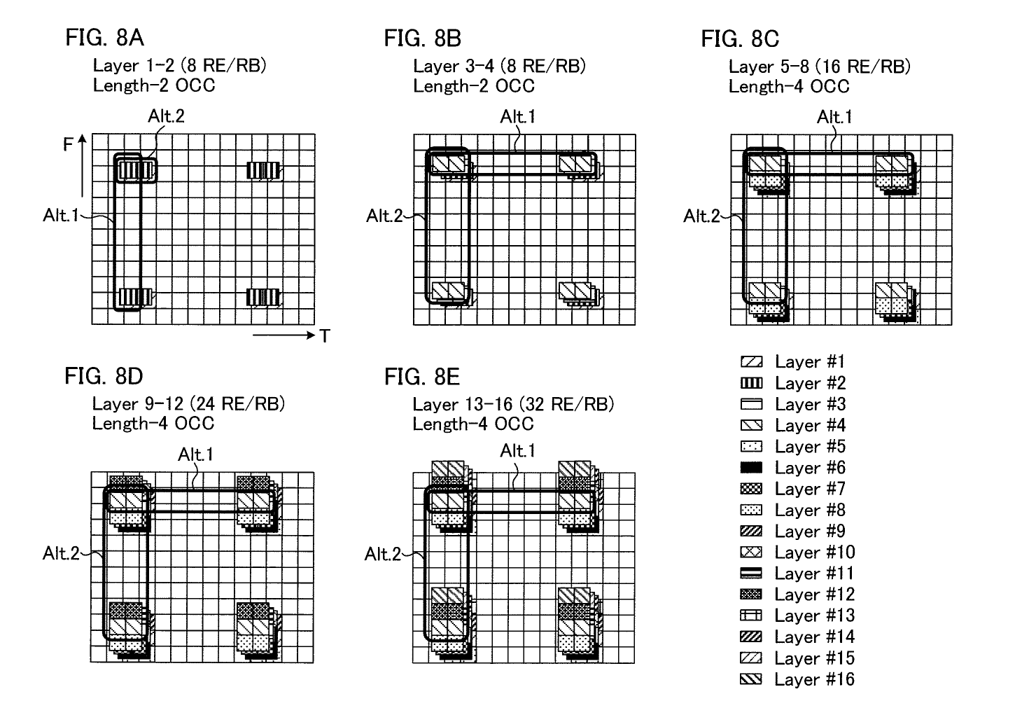

In a sixth example of an embodiment of the invention, the number of REs of the reference signals per one RB, with respect to the same number of layers, is less than the number of REs in an existing DMRS configuration. FIG. 8 shows reference signal configurations and orthogonalization application ranges pertaining to a sixth example of the present invention. In the resource allocation of the reference signals of FIG. 8, with respect to the same number of layers, the number of REs (four REs) in the time direction is the same as that of the existing DMRS configuration shown in FIG. 2 and the number of REs (two REs) in the frequency direction is less. In this case, the number of allocation REs for the reference signal is 8.

In the present example, even if the number of layers is increased (e.g., even in the case of 13 through 16 layers), the maximum code length can be set to 4. In other words, compared to the reference signal configurations of the other embodiments, the number of reference signals that are multiplexed in one RE can be maintained as few as possible while including a large number of reference signals within one RB.

According to the above-described sixth example, because the number of allocated REs per layer is less than that of an existing reference signal configuration, the overhead for the reference signals can be reduced.

Note that the configuration of FIG. 8 can be combined with the concentrated RE allocation configurations shown in FIG. 4. For example, in at least some of the layers, the REs of the reference signals of FIG. 8 may be allocated adjacent to each other by a plural number (e.g., by fours) in the time direction. Furthermore, in at least some of the layers, the REs of the reference signals of FIG. 8 may be allocated adjacent to each other by a plural number (e.g., by twos) in the frequency direction. Accordingly, it can be expected that a trade-off between concentrated allocation and distributed allocation can be achieved.

According to the above-described first embodiment, the UE can change the reference signal configuration and/or the orthogonalization application range based on the RAT communication parameters and the conditions, etc., of the UE's terminal. For example, in the case where the symbol length used in RAT is short or the time selectivity is relatively high for a channel in which the UE mobile speed is high, etc., the UE performs a control to use a reference signal configuration in which the REs are allocated in a concentrated manner in the time direction or to use an orthogonalization application range that includes a frequency direction, so that a reduction in the influence of phasing, thereby favorably suppressing a reduction in channel estimation precision, can be expected.

Furthermore, in the case where the sub-carrier spacing used by RAT is long, if the frequency selectivity is relatively high for a channel in which the UE mobile speed is low, etc., the UE performs a control to use a reference signal configuration in which the REs are allocated in a distributed manner in the time direction or to use an orthogonalization application range that includes a time direction, so that a reduction in the influence of multipath delay, thereby favorably suppressing a reduction in channel estimation precision, can be expected.

Note that the above-described first through sixth examples are merely examples of the first embodiment; other reference signal configurations and/or orthogonalization application ranges may be utilized. Furthermore, in the above-described examples, although orthogonalization has been applied to a plurality of RE groups, in the same layer, within the closet regions in the time and/or frequency directions, the orthogonalization application ranges are not limited thereto. For example, orthogonalization may be applied to a plurality of RE groups, in the same layer, that are the n^{th} (n>1) closest in the time and/or frequency directions, or may be applied to a plurality of REs at positions derived in accordance with a predetermined rule (e.g., a hopping pattern).

### Second Embodiment

In a second embodiment of the present invention, the UE receives information regarding reference signal configurations and/or orthogonalization application ranges, and determines a reference signal and/or orthogonalization application range to use based on such information. Such information may be referred to as, e.g., “reference signal configuration information” or “orthogonalization application range information” regardless of whether or not other information is also included therein.

Such information may be dynamically or quasi-statically notified to the UE by either higher layer signaling (e.g., RRC (Radio Resource Control) signaling, broadcast information (MIB (Master Information Block), SIB (System Information Block) etc.), or MAC (Medium Access Control) signaling) or downlink control information (e.g., DCI (Downlink Control Information)), or a combination thereof. Such information may be individually notified to the UE using RRC signaling or a DCI, etc., or may be notified as broadcast information together with a plurality of UEs within a cell.

The eNB may uniquely decide the reference signal configuration and/or orthogonalization application range in accordance with sub-carrier spacing used in reference-signal allocation, usage frequency (e.g., carrier frequency (central frequency)), and the number of symbols and/or number of sub-carriers that configure a minimum control unit (e.g., one RB). The eNB may determine to use a different orthogonalization application range, even if the reference signal configuration is the same, in accordance with the number of layers (number of antenna ports) that are applied (set) to the UE. In addition to communication parameters, the eNB may determine the reference signal configuration and/or orthogonalization application range based on the mobile speed of the UE or the channel state between the eNB and the UE.

Note that the UE may transmit UE capability information regarding reference signal configurations and/or orthogonalization application ranges that the UE can deal with to the network side (e.g., the eNB). The eNB can control the reference signal configurations and/or orthogonalization application ranges that can be applied to the UE based on the UE capability information. Furthermore, also in regard to the uplink, the UE may notify the eNB of the UE capability information regarding reference signal configurations and/or orthogonalization application ranges that the UE can deal with.

According to the second embodiment, because the eNB can set the reference signal configurations and/or orthogonalization application ranges for each UE, differences in recognition of resource allocation between the eNB and the UE can be favorably avoided.

Note that the second embodiment may be used in combination with the first embodiment. Specifically, one (e.g., the reference signal configuration) of the reference signal configuration and the orthogonalization application range can be decided by the eNB and notified to the UE, and the other (e.g., the orthogonalization application range) thereof may be decided by the UE.

### Modified Embodiments

Although downlink reference signals have been described in the above embodiments, application of the present invention is not limited thereto. For example, an uplink reference signal configuration and/or a coding application scope may be uniquely decided in accordance with RAT communication parameters (e.g., sub-carrier spacing, carrier frequency, the number of symbols and/or number of sub-carriers in one RB, etc.). Furthermore, a different orthogonalization application range to be used may be determined in accordance with the number of layers (the number of antenna ports) applied (set) to the UE. Furthermore, the reference signal configuration and/or orthogonalization application range may be determined based on, in addition to communication parameters, the UE mobile speed or the channel state between the UE and the eNB.

With regard to the uplink also, e.g., the reference signal configurations and/or orthogonalization application ranges indicated in the above-described first through sixth examples may be used, or other reference signal configurations and/or orthogonalization application ranges may be used. The reference signal configurations and/or orthogonalization application ranges for the uplink may be autonomously decided by the eNB, or may be autonomously decided by the UE.

Note that information regarding the determined reference signal configurations and/or orthogonalization application ranges may be notified from the eNB to the UE, or may be notified from the UE to the eNB. Furthermore, such notification may be dynamically or quasi-statically carried out using higher layer signaling (e.g., RRC signaling), downlink control information (e.g., DCI), or uplink control information (e.g., UCI (Uplink Control Information)), etc. Furthermore, with regard to the uplink also, the UE may notify the eNB of the UE capability information regarding reference signal configurations and/or orthogonalization application ranges that the UE can deal with.

Note that in the above-described embodiments, a case is indicated in which, under the condition that some code elements of an orthogonal code are configured to overlap with at least some of the reference signal REs in a predetermined direction of the orthogonalization application range, the number of REs of the reference signal in such a direction is not equal to a multiple of the code length of the orthogonal code that is applied to the reference signal; however, the present invention is not limited thereto. For example, if the number of REs of a reference signal in a predetermined direction is equal to a multiple of the code length of the orthogonal code, a configuration is possible in which some of the code elements overlap with the orthogonal code in such a predetermined direction.

Furthermore, the configurations described in each embodiment of the present invention can be applied without depending on a radio access scheme. For example, embodiments of the present invention can be applied even if the radio access scheme that is utilized in the downlink (uplink) is Orthogonal Frequency Division Multiple Access (OFDMA), Single-Carrier Frequency Division Multiple Access (SC-FDMA) or another radio access scheme. In other words, the symbols indicated in each embodiment are not limited to OFDM symbols or SC-FDMA symbols. Note that only in the case where the radio access scheme is an OFDM based scheme utilized in the downlink (uplink) can a configuration be provided which determines the reference signal configuration and/or coding application scope.

Furthermore, the above-described examples indicated a reference signal configuration that is set by an existing one RB (14 symbols×12 sub-carriers) unit, however, the present invention is not limited thereto. The reference signal configuration may be set using a new predetermined region unit (e.g., may be referred to an enhanced RB (eRB), etc.) prescribed as a radio resource region that is different to the existing one RB, or may be set using a plurality of RB units. Furthermore, the orthogonalization application range may also be applied to a radio resource region corresponding to the reference signal configuration.

Furthermore, the reference signal configurations and/or orthogonalization application ranges may be differentiated based on parameters other than communication parameters (numerology) such as sub-carrier spacing and carrier frequency, etc., that are indicated in the above-described examples. Furthermore, the above-described radio communication method can be applied even if the maximum number of layers is greater than 16.

Furthermore, the above-described radio communication method is not limited to New RAT, and may be applied to an existing LTE RAT or another RAT. Furthermore, the above-described radio communication method can be applied to both a Primary Cell (PCell) and a Secondary Cell (SCell), or can be applied to only one thereof. For example, the above-described radio communication method may be applied only in a licensed band (or in a carrier to which listening has not been configured), or the above-described radio communication method may be applied only in an unlicensed band (or in a carrier to which listening has not been configured).

Furthermore, the above-described radio communication method may be applied to other signals (e.g., data signals, control signals, etc.) used in the orthogonalization scheme other than reference signals. In such a case, the above-mentioned term “reference signal configuration” can simply be replaced with “signal configuration”.

(Radio Communication System)

The following description concerns the configuration of a radio communication system according to one or more embodiments of the present invention. In this radio communication system, the radio communication methods of the above-described embodiments can be applied independently, or in combination.

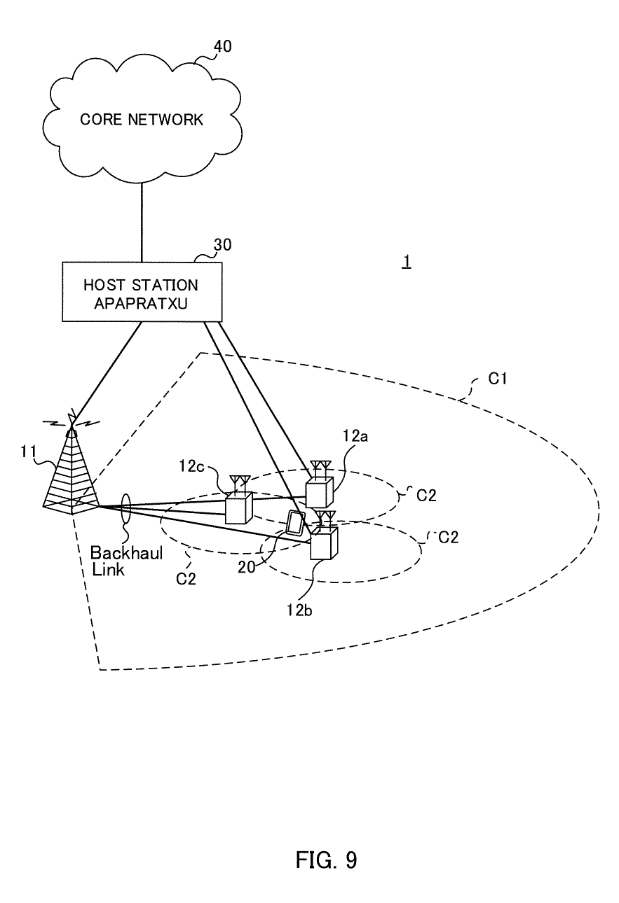

FIG. 9 shows an example of a schematic configuration of the radio communication system according to an embodiment of the present invention. The radio communication system 1 can apply carrier aggregation (CA) and/or dual connectivity (DC), which are an integration of a plurality of fundamental frequency blocks (component carriers), having the system bandwidth (e.g., 20 MHz) as 1 unit.

Note that this radio communication system may also be referred to as Long Term Evolution (LTE), LTE-Advanced (LTE-A), LTE-Beyond (LTE-B), SUPER 3G, IMT-Advanced, 4^{th} Generation Mobile Communication System (4G), 5^{th} Generation Mobile Communication System (5G), Future Radio Access (FRA), New-RAT (Radio Access Technology), etc., or referred to as a system that achieves these.

The radio communication system 1 shown in FIG. 9 includes a radio base station 11 which forms a macro cell C1 having a relative wide coverage, and a radio base station 12 (12a through 12c) provided within the macro cell C1 and forming a small cell C2 that is smaller than the macro cell C1. Furthermore, a user terminal 20 is provided within the macro cell C1 and each small cell C2.

The user terminal 20 can connect both to the radio base station 11 and the radio base station 12. It is assumed that the user terminal 20 concurrently uses the macro cell C1 and the small cells C2 via CA or DC. Furthermore, the user terminal 20 can apply CA or DC using a plurality of cells (CCs) (e.g., five or less CCs, or six or more CCs).

Communication between the user terminal 20 and the radio base station 11 can be carried out using a carrier (called an “existing carrier”, “Legacy carrier”, etc.) having a narrow bandwidth in a relatively low frequency band (e.g., 2 GHz). Whereas, communication between the user terminal 20 and the radio base station 12 may be carried out using a carrier (e.g., a New RAT carrier) having a wide bandwidth in a relative high frequency band (e.g., 3.5 GHz, 5 GHz, etc.), or using the same carrier as that with the radio base station 11. Note that the configuration of the frequency used by the radio base stations is not limited to the above.

A fixed-line connection (e.g., optical fiber, or X2 interface, etc., compliant with CPRI (Common Public Radio Interface)) or a wireless connection can be configured between the radio base station 11 and the radio base station 12 (or between two radio base stations 12).

The radio base station 11 and each radio base station 12 are connected to a host station apparatus 30, and are connected to the core network 40 via the host station apparatus 30. The host station apparatus 30 includes, but is not limited to, an access gateway apparatus, a radio network controller (RNC), and a mobility management entity (MME), etc. Furthermore, each radio base station 12 may be connected to the host station apparatus 30 via the radio base station 11.

Note that the radio base station 11 is a radio base station having a relatively wide coverage, and may be called a macro base station, an aggregation node, eNB (eNodeB) or a transmission/reception point. Furthermore, the radio base station 12 is a radio base station having local coverage, and may be called a small base station, a micro base station, a pico base station, a femto base station, Home eNodeB (HeNB), Remote Radio Head (RRH), or a transmission/reception point, etc. Hereinafter, the radio base stations 11 and 12 will be generally referred to as “a radio base station 10” in the case where they are not distinguished.

Each user terminal 20 is compatible with each kind of communication scheme such as LTE, LTE-A, etc., and also includes a fixed communication terminal in addition to a mobile communication terminal.

In the radio communication system 1, Orthogonal Frequency Division Multiple Access (OFDMA) is applied to the downlink and Single-Carrier Frequency Division Multiple Access (SC-FDMA) is applied to the uplink as radio access schemes. OFDMA is a multi-carrier transmission scheme for performing communication by dividing a frequency band into a plurality of narrow frequency bands (subcarriers) and mapping data to each subcarrier. SC-FDMA is a single carrier transmission scheme to reduce interference between terminals by dividing, per terminal, the system bandwidth into bands formed with one or continuous resource blocks, and allowing a plurality of terminals to use mutually different bands. Note that the uplink and downlink radio access schemes are not limited to these combinations.

In the radio communication system 1, a downlink shared channel (Physical Downlink Shared Channel (PDSCH)) that is shared by each user terminal 20, a broadcast channel (Physical Broadcast channel (PBCH)), and an L1/L2 control channel, etc., are used as downlink channels. User data and higher layer control information, and a System Information Block (SIB) are transmitted on the PDSCH. Furthermore, a Master Information Block (MIB), etc., is transmitted on the PBCH.

The downlink L1/L2 control channel includes a Physical Downlink Control Channel (PDCCH), an Enhanced Physical Downlink Control Channel (EPDCCH), a Physical Control Format Indicator Channel (PCFICH), and a Physical Hybrid-ARQ Indicator Channel (PHICH), etc. Downlink control information (DCI), etc., which includes PDSCH and PUSCH scheduling information, is transmitted by the PDCCH. The number of OFDM symbols used in the PDCCH is transmitted by the PCFICH. A Hybrid Automatic Repeat Request (HARQ) delivery acknowledgement signal (referred to as, e.g., retransmission control information, HARQ-ACK, ACK/NACK, etc.) for the PUSCH is transmitted by the PHICH. An EPDCCH that is frequency-division-multiplexed with a downlink shared data channel (PDSCH) can be used for transmitting the DCI in the same manner as the PDCCH.

In the radio communication system 1, an uplink shared channel (Physical Uplink Shared Channel (PUSCH)) that is shared by each user terminal 20, an uplink control channel (Physical Uplink Control Channel (PUCCH)), and a random access channel (Physical Random Access Channel (PRACH), etc., are used as uplink channels. The PUSCH is used to transmit user data and higher layer control information. Furthermore, uplink control information (UCI) including at least one of downlink radio quality information (Channel Quality Indicator (CQI)) and delivery acknowledgement information, etc., are transmitted via the PUCCH. A random access preamble for establishing a connection with a cell is transmitted by the PRACH.

In the radio communication system 1, a cell-specific reference signal (CRS), channel state information reference signal (CSI-RS), a demodulation reference signal (DMRS), and a positioning reference signal (PRS), etc., are transmitted as downlink reference signals. Furthermore, in the radio communication system 1, a measurement reference signal (Sounding Reference Signal (SRS)) and a demodulation reference signal (DMRS), etc., are transmitted as uplink reference signals. Note that the DMRS may be referred to as a user terminal specific reference signal (UE-specific reference signal). Furthermore, the transmitted reference signals are not limit to the above.

(Radio Base Station)

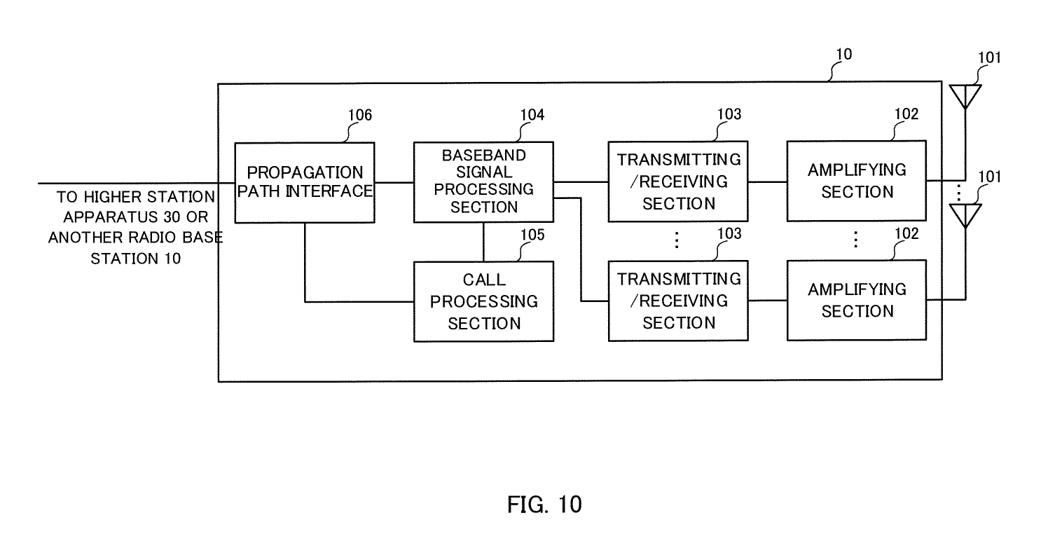

FIG. 10 is a diagram illustrating an overall configuration of the radio base station according to an embodiment of the present invention. The radio base station 10 is configured of a plurality of transmission/reception antennas 101, amplifying sections 102, transmitting/receiving sections 103, a baseband signal processing section 104, a call processing section 105 and a transmission path interface 106. Note that the transmission/reception antennas 101, the amplifying sections 102, and the transmitting/receiving sections 103 may be configured to include one or more thereof, respectively.

User data that is to be transmitted on the downlink from the radio base station 10 to the user terminal 20 is input from the host station apparatus 30, via the transmission path interface 106, into the baseband signal processing section 104.

In the baseband signal processing section 104, in regard to the user data, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control (e.g., HARQ transmission processing), scheduling, transport format selection, channel coding, inverse fast Fourier transform (IFFT) processing, and precoding processing, and resultant signals are transferred to the transmission/reception sections 103. Furthermore, in regard to downlink control signals, transmission processing is performed, including channel coding and inverse fast Fourier transform, and resultant signals are also transferred to the transmission/reception sections 103.

Each transmitting/receiving section 103 converts the baseband signals, output from the baseband signal processing section 104 after being precoded per each antenna, to a radio frequency band and transmits this radio frequency band. The radio frequency signals that are subject to frequency conversion by the transmitting/receiving sections 103 are amplified by the amplifying sections 102, and are transmitted from the transmission/reception antennas 101. Based on common recognition in the field of the art pertaining to the present invention, each transmitting/receiving section 103 can be configured as a transmitter/receiver, a transmitter/receiver circuit or a transmitter/receiver device. Note that each transmitting/receiving section 103 may be configured as an integral transmitting/receiving section or may be configured as a transmitting section and a receiving section.

Whereas, with regard to the uplink signals, radio frequency signals received by each transmission/reception antenna 101 are amplified by each amplifying section 102. The transmitting/receiving sections 103 receive the uplink signals that are amplified by the amplifying sections 102, respectively. The transmitting/receiving sections 103 frequency-convert the received signals into baseband signals and the converted signals are then output to the baseband signal processing section 104.

The baseband signal processing section 104 performs Fast Fourier Transform (FFT) processing, Inverse Discrete Fourier Transform (IDFT) processing, error correction decoding, MAC retransmission control reception processing, and RLC layer and PDCP layer reception processing on user data included in the input uplink signals. The signals are then transferred to the host station apparatus 30 via the transmission path interface 106. The call processing section 105 performs call processing such as releasing a communication channel, manages the state of the radio base station 10, and manages the radio resources.

The transmission path interface 106 performs transmission and reception of signals with the host station apparatus 30 via a predetermined interface. Furthermore, the transmission path interface 106 can perform transmission and reception of signals (backhaul signaling) with another radio base station 10 via an inter-base-station interface (for example, optical fiber or X2 interface compliant with Common Public Radio Interface (CPRI)).

Note that the transmitting/receiving sections 103 can transmit and/or receive predetermined signals (e.g., reference signals) in a predetermined radio resource in accordance with a reference signal configuration determined by the control section 301. Furthermore, the transmitting/receiving sections 103 may receive information regarding reference signal configurations and/or orthogonalization application ranges from the user terminal 20.

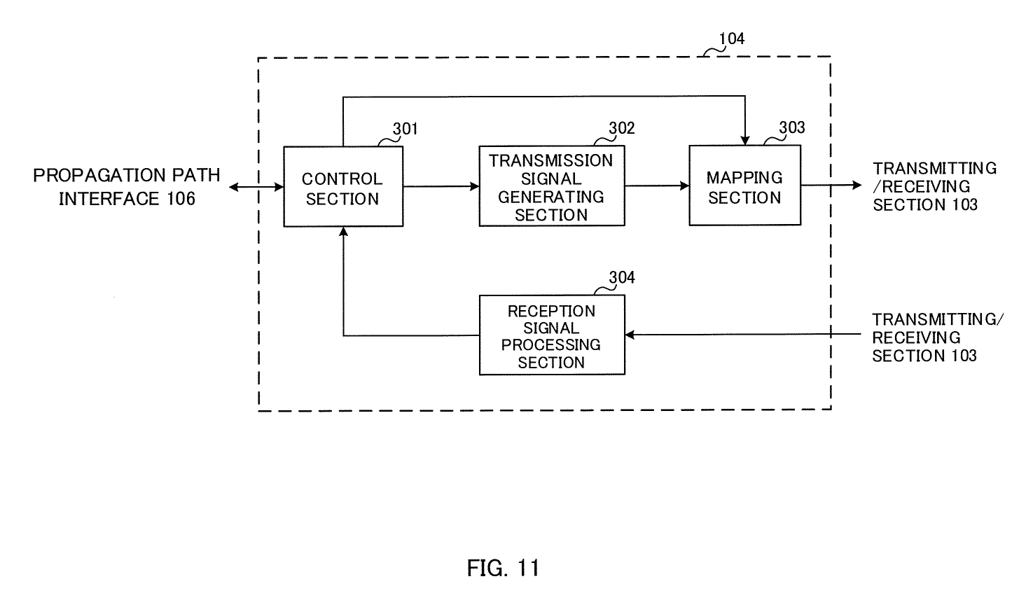

FIG. 11 is a diagram illustrating the functional configurations of the radio base station according to the present embodiment. Note that although FIG. 11 mainly shows functional blocks of the features in accordance with one or more embodiments of the present embodiment, the radio base station 10 is also provided with other functional blocks that are necessary for carrying out radio communication. As illustrated in FIG. 11, the baseband signal processing section 104 is provided with at least a control section (scheduler) 301, a transmission signal generating section 302, a mapping section 303, a reception signal processing section 304, and a measuring section 305.

The control section (scheduler) 301 performs the entire control of the radio base station 10. Based on common recognition in the field of the art pertaining to the present invention, the control section 301 can be configured as a controller, a control circuit or a control device.

The control section 301 controls, e.g., the generation of signals by the transmission signal generating section 302, and the allocation of signals by the mapping section 303. Furthermore, the control section 301 controls the reception processes of signals by the reception signal processing section 304, and the measurement of signals by the measuring section 305.

The control section 301 controls the scheduling (e.g., resource allocation) of the system information, downlink data signals transmitted by a PDSCH, and downlink control signals transmitted by a PDCCH and/or EPDCCH. Furthermore, control of scheduling of downlink reference signals such as synchronization signals (Primary Synchronization Signal (PSS)/Secondary Synchronization Signal (SSS), CRSs, CSI-RSs, DMRSs, etc., is carried out.

Furthermore, the control section 301 controls the scheduling of the uplink data signals transmitted in a PDSCH, the uplink control signals transmitted by a PUCCH and/or a PUSCH (e.g., delivery acknowledgment signal), a random access preamble transmitted by a PRACH, and an uplink reference signal, etc.

Specifically, the control section 301 performs a control for the radio base station 10 to carry out communication with a predetermined user terminal 20 using a predetermined radio access scheme (e.g., LTE RAT or New RAT). The control section 301 may perform a control to receive a predetermined signal (e.g., reference signal) in a specified radio resource and carry out a reception process (e.g., demapping, demodulation, decoding, etc.) on the predetermined signal based on a specified orthogonalization application range. Furthermore, the control section 301 may perform a control to apply a transmission process (orthogonalization, etc.) on a predetermined signal (e.g., a reference signal) based on a specified orthogonalization application range, and transmit the predetermined signal in a specified radio resource.

Furthermore, the control section 301 may determine a reference signal configuration and/or orthogonalization application range while considering, in addition to communication parameters, the number of layers (number of antenna ports) applied (set) in the radio base station 10 and/or user terminal 20, the mobile speed of the user terminal 20, and the channel state between the user terminal 20 and the radio base station 10, etc. The control section 301 may discern the channel characteristics (time selectivity, frequency selectivity, etc.) between the radio base station 10 and the user terminal 20, based on the channel state that is input from the measuring section 305 or information notified by the user terminal 20, etc., and utilize this information for the above-described determination.

The control section 301 may decide on (determine/specify) at least one of the above-mentioned specified radio resource and the above-mentioned specified reference signal configuration and/or orthogonalization application range based on communication parameters (sub-carrier spacing, central frequency of carrier, the number of symbols and/or number of sub-carriers that configure a predetermined radio resource region (e.g., one RB)) used in the above-mentioned specified radio access scheme.

Furthermore, the control section 301 may determine a reference signal configuration and/or orthogonalization application range to use based on information regarding reference signal configurations and/or orthogonalization application ranges received from the user terminal 20.

The control section 301 may perform a control to use the reference signal configurations and/or orthogonalization application ranges indicated in the above-described first through sixth examples, or may perform a control to use other reference signal configurations and/or orthogonalization application ranges.

Furthermore, the control section 301 may control the reception signal processing section 304 or the transmitting/receiving sections 103 to perform a reception/transmission process on the predetermined signal, in at least one layer, using a code length that is different to that of another layer, based on the reference signal configuration, coding application scope and number of layers, etc.

Furthermore, in the case where the number of reference signal REs in a predetermined direction, within a predetermined radio resource region (e.g., one RB), is not equal to a multiple (or a divisor) of a code length of an orthogonal code (OCC), the control section 301 may perform a control to carry out a reception/transmission process while considering at least one code element of the orthogonal code that overlaps at least one of the reference signal REs.

The transmission signal generating section 302 generates a downlink signal (a downlink control signal, a downlink data signal, or a downlink reference signal, etc.) based on instructions from the control section 301, and outputs the generated signal to the mapping section 303. Based on common recognition in the field of the art pertaining to the present invention, the transmission signal generating section 302 can be configured as a signal generator or a signal generating circuit.

The transmission signal generating section 302 generates, based on instructions form the control section 301, a DL assignment that notifies allocation information of a downlink signal and a UL grant that notifies allocation information of an uplink signal. Furthermore, an encoding process and a modulation process are carried out on the downlink data signal in accordance with a coding rate and modulation scheme that are determined based on channel state information (CSI), etc., that is notified from each user terminal 20.

Based on instructions from the control section 301, the mapping section 303 maps the downlink signal generated in the transmission signal generating section 302 to a predetermined radio resource(s) to output to the transmitting/receiving sections 103. Based on common recognition in the field of the art pertaining to the present invention, the mapping section 303 can be configured as a mapper, a mapping circuit and a mapping device.

The reception signal processing section 304 performs a receiving process (e.g., demapping, demodulation, and decoding, etc.) on a reception signal input from the transmitting/receiving section 103. The reception signal can be, for example, an uplink signal (uplink control signal, uplink data signal, uplink reference signal, etc.) transmitted from the user terminal 20. Based on common recognition in the field of the art pertaining to the present invention, the reception signal processing section 304 can be configured as a signal processor, a signal processing circuit, or a signal processing device.

The reception signal processing section 304 outputs information that is encoded by the reception process to the control section 301. For example, in the case where a PUCCH including an HARQ-ACK is received, the HARQ-ACK is output to the control section 301. Furthermore, the reception signal processing section 304 outputs a reception signal or a reception-processed signal to the measuring section 305.

The measuring section 305 carries out a measurement on the received signal. Based on common recognition in the field of the art pertaining to the present invention, the measuring section 305 can be configured as a measurer, a measuring circuit or a measuring device.

The measuring section 305 may measure, e.g., the reception power of the received signal (e.g., RSRP (Reference Signal Received Power)), reception signal strength (e.g., RSSI (Received Signal Strength Indicator), the reception quality (e.g., RSRQ (Reference Signal Received Quality)), and the channel quality, etc. The measurement results may be output to the control section 301.

<User Terminal>

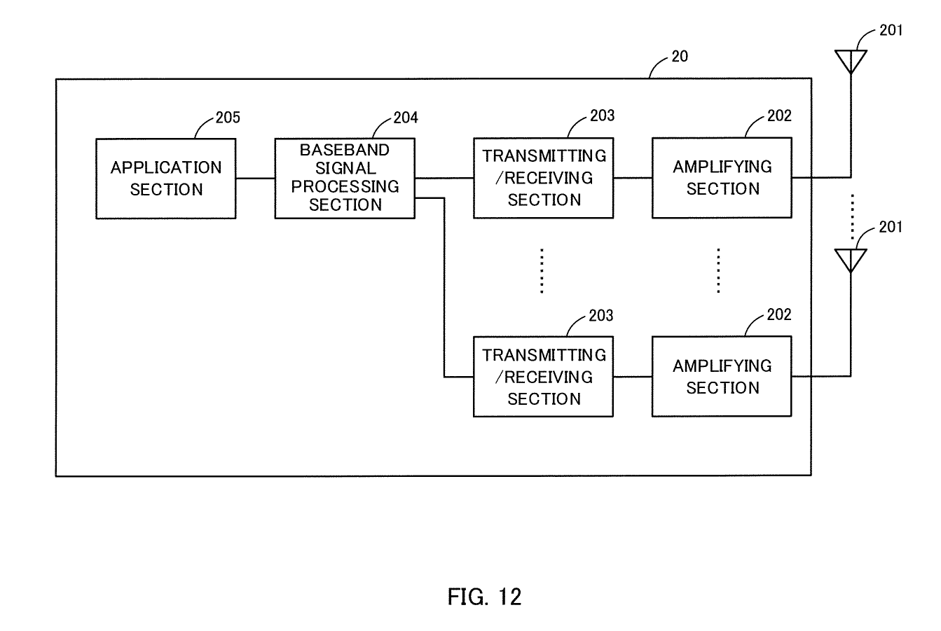

FIG. 12 is a diagram showing an illustrative example of an overall structure of a user terminal according to one or more embodiments of the present invention. The user terminal 20 is provided with a plurality of transmitting/receiving antennas 201, amplifying sections 202, transmitting/receiving sections 203, a baseband signal processing section 204 and an application section 205. Note that each of the transmitting/receiving antennas 201, the amplifying sections 202, and the transmitting/receiving sections 203 only need to be configured of one of more thereof, respectively.

Radio frequency signals that are received in the transmitting/receiving antennas 201 are respectively amplified in the amplifying sections 202. Each transmitting/receiving section 203 receives a downlink signal that has been amplified by an associated amplifying section 202. The transmitting/receiving sections 203 perform frequency conversion on the reception signals to convert into baseband signals, and are thereafter output to the baseband signal processing section 204. Based on common recognition in the field of the art pertaining to the present invention, each transmitting/receiving section 203 can be configured as a transmitter/receiver, a transmitter/receiver circuit or a transmitter/receiver device. Note that each transmitting/receiving sections 203 can be configured as an integral transmitting/receiving section, or can be configured as a transmitting section and a receiving section.

The input baseband signal is subjected to an FFT process, error correction decoding, a retransmission control receiving process, etc., in the baseband signal processing section 204. The downlink user data is forwarded to the application section 205. The application section 205 performs processes related to higher layers above the physical layer and the MAC layer. Furthermore, out of the downlink data, broadcast information is also forwarded to the application section 205.

On the other hand, uplink user data is input to the baseband signal processing section 204 from the application section 205. In the baseband signal processing section 204, a retransmission control transmission process (e.g., a HARQ transmission process), channel coding, precoding, a discrete fourier transform (DFT) process, an inverse fast fourier transform (IFFT) process, etc., are performed, and the result is forwarded to each transmitting/receiving section 203. The baseband signal that is output from the baseband signal processing section 204 is converted into a radio frequency band in the transmitting/receiving sections 203. Thereafter, the amplifying sections 202 amplify the radio frequency signal having been subjected to frequency conversion, and transmit the resulting signal from the transmitting/receiving antennas 201.

Note that the transmitting/receiving sections 203 can transmit and/or receive predetermined signals (e.g., reference signals) in a predetermined radio resource in accordance with a reference signal configuration determined by the control section 401. Furthermore, the transmitting/receiving sections 203 may receive information regarding reference signal configurations and/or orthogonalization application ranges from the radio base station 10.

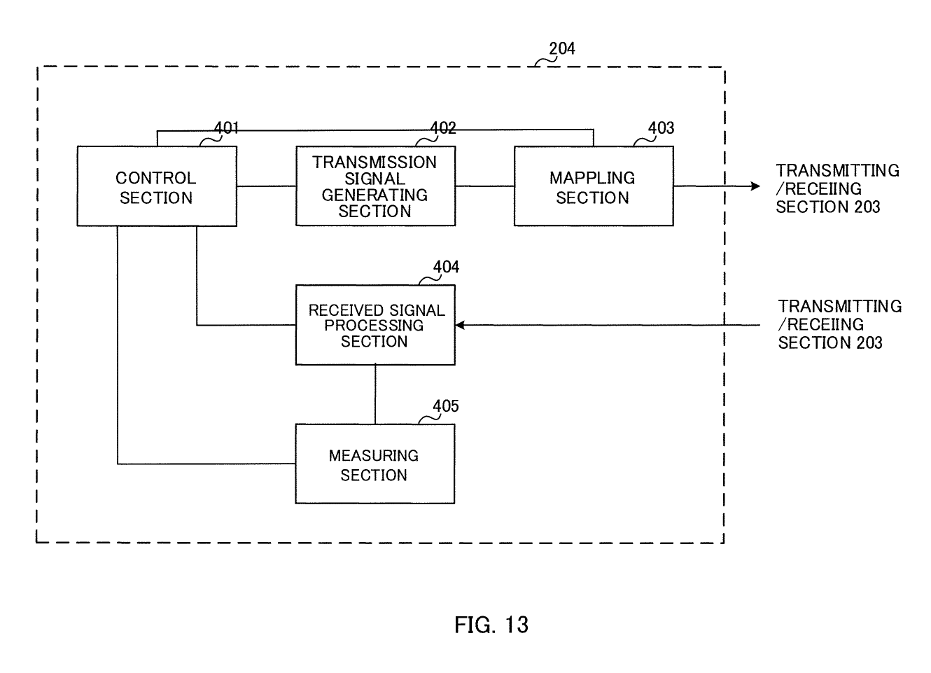

FIG. 13 is a diagram illustrating the functional configurations of the user terminal according to one or more embodiments of the present invention. Note that FIG. mainly shows functional blocks of the features of the present embodiment; the user terminal 20 is also provided with other functional blocks that are necessary for carrying out radio communication. As illustrated in FIG. 15, the baseband signal processing section 204 provided in the user terminal 20 includes a control section 401, a transmission signal generating section 402, a mapping section 403, a reception signal processing section 404, and a measuring section 405.

The control section 401 carries out the control of the entire user terminal 20. Based on common recognition in the field of the art pertaining to the present invention, the control section 401 can be configured as a controller, a control circuit or a control device.

The control section 401 controls, e.g., the generation of signals by the transmission signal generating section 402, and the allocation of signals by the mapping section 403. Furthermore, the control section 401 controls the reception processes of signals by the reception signal processing section 404, and the measurement of signals by the measuring section 405.

The control section 401 obtains a downlink control signal (a signal transmitted on a PDCCH/EPDCCH) transmitted from the radio base station 10 and a downlink data signal (a signal transmitted on a PDSCH) from the reception signal processing section 404. The control section 401 controls the generation of an uplink control signal (e.g., a delivery acknowledgement signal, etc.) and the generation of an uplink data signal based on a determination result on whether or not a retransmission control is necessary for the downlink control signal and the downlink data signal.

Specifically, the control section 401 controls the user terminal 20 to carry transmission using a predetermined radio access scheme (e.g., LTE RAT or New RAT). The control section 401 may receive a predetermined signal (e.g., a reference signal) in a specified radio resource, and perform a control to carry out a reception process (e.g., demapping, demodulation, decoding, etc.) on the predetermined signal based on the specified orthogonalization application range. Furthermore, the control section 401 may perform a control to apply a transmission process (orthogonalization, etc.) on a predetermined signal (e.g., a reference signal) based on a specified orthogonalization application range, and transmit the predetermined signal in a specified radio resource.

Furthermore, the control section 401 may determine a reference signal configuration and/or orthogonalization application range while considering, in addition to communication parameters, the number of layers (number of antenna ports) applied (set) in the user terminal 20, the mobile speed of the user terminal 20, and the channel state between the radio base station 10 and the user terminal 20, etc. The control section 401 may discern the channel characteristics (time selectivity, frequency selectivity, etc.) between the radio base station 10 and the user terminal 20, based on the channel state that is input from the measuring section 405 or information notified by the radio base station 10, etc., and utilize this information for the above-described determination.

The control section 401 may decide on (determine/specify) at least one of the above-mentioned specified radio resource and the above-mentioned specified reference signal configuration and/or orthogonalization application range based on communication parameters (sub-carrier spacing, central frequency of carrier, the number of symbols and/or number of sub-carriers that configure a predetermined radio resource region (e.g., one RB)) used in the above-mentioned specified radio access scheme (first embodiment).

Furthermore, the control section 401 may determine a reference signal configuration and/or orthogonalization application range to use based on information regarding reference signal configurations and/or orthogonalization application ranges received from the radio base station 10 (second embodiment).

The control section 401 may perform a control to use the reference signal configurations and/or orthogonalization application ranges indicated in the above-described first through sixth examples, or may perform a control to use other reference signal configurations and/or orthogonalization application ranges. For example, specified radio resources to which a predetermined signal is allocated, based on the reference signal configuration, may have the same radio resource set for both the number of resource elements in the time direction and the number of resource elements in the frequency direction, or at least one thereof may have a different radio resource set compared to the reference signal configuration of an existing LTE system.

Furthermore, the control section 401 may control the reception signal processing section 404 or the transmitting/receiving sections 203, etc., to perform a reception/transmission process on the predetermined signal, in at least one layer, using a code length that is different to that of another layer, based on the reference signal configuration, coding application scope and number of layers, etc.

Furthermore, the control section 401 may perform a control to carry out a reception/transmission process while considering at least one code element of the orthogonal code, applied to the reference signal, that overlaps at least one of the reference signal REs within a predetermined radio resource region (e.g., one RB). For example, in the case where the number of reference signal REs in a predetermined direction, within a predetermined radio resource region (e.g., one RB), is not equal to a multiple (or a divisor) of a code length of an orthogonal code (OCC), the control section 401 may perform a control to carry out the reception/transmission process, or in the case where the number of the reference signal REs are equal to the multiple (or the divisor), to perform a control to carry out the reception/transmission process.

The transmission signal generating section 402 generates an uplink signal (an uplink control signal, an uplink data signal, or an uplink reference signal, etc.) based on instructions from the control section 401, and outputs the generated signal to the mapping section 403. Based on common recognition in the field of the art pertaining to the present invention, the transmission signal generating section 402 can be configured as a signal generator, a signal generating circuit, or a signal generating device.

For example, the transmission signal generating section 402 generates an uplink control signal of a delivery acknowledgement signal or channel state information (CSI), etc., based on instructions from the control section 401. Furthermore, the transmission signal generating section 402 generates an uplink data signal based on instructions from the control section 401. For example, in the case where a UL grant is included in a downlink control signal notified by the radio base station 10, the transmission signal generating section 402 is instructed by the control section 401 to generate an uplink data signal.

The mapping section 403 maps the uplink signal generated by the transmission signal generating section 402, based on instructions from the control section 401, to radio resources and outputs the generated signal to the transmitting/receiving sections 203. Based on common recognition in the field of the art pertaining to the present invention, the mapping section 403 can be configured as a mapper, a mapping circuit or a mapping device.

The reception signal processing section 404 performs reception processing (e.g., demapping, demodulation, decoding, etc.) on the reception signal input from the transmitting/receiving sections 203. The reception signal can be, for example, a downlink signal transmitted from the radio base station 10 (downlink control signal, downlink data signal, downlink reference signal, etc.). Based on common recognition in the field of the art pertaining to the present invention, the reception signal processing section 404 can correspond to a signal processor, a signal processing circuit, or a signal processing device; or a measurer, a measuring circuit or a measuring device. Furthermore, the reception signal processing section 404 can be configured as a receiving section pertaining to the present invention.

The reception signal processing section 404 outputs information that is decoded by a reception process to the control section 401. The reception signal processing section 404 outputs, e.g., broadcast information, system information, RRC signaling, and the DCI(s) to the control section 401. Furthermore, the reception signal processing section 404 outputs reception signals, and signals subjected to reception processing to the measuring section 405.

The measuring section 405 carries out a measurement on the received signals. Based on common recognition in the field of the art pertaining to the present invention, the measuring section 405 can be configured as a measurer, a measuring circuit or a measuring device.

The measuring section 405 may measure, e.g., the reception power of the received signal (e.g., RSRP), the reception signal strength (e.g., RSSI), the reception quality (e.g., RSRQ), and the channel quality, etc. The measurement results may be output to the control section 401.

(Hardware Configuration)

The block diagrams used in the above descriptions of embodiments of the present invention indicate function-based blocks. These functional blocks (configured sections) are implemented via a combination of hardware and/or software. Furthermore, the implementation of each functional block is not limited to a particular means. In other words, each functional block may be implemented by a single device that is physically connected, or implemented by two or more separate devices connected by a fixed line or wirelessly connected.

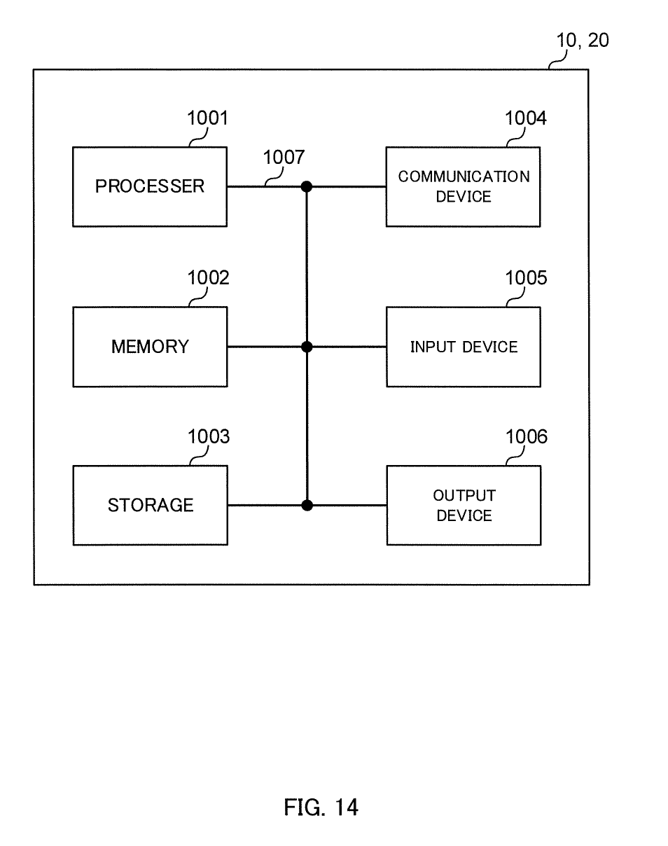

For example, the radio base station or user terminal, etc., of the illustrated embodiment of the present invention may function as a computer that carries out the processes of the radio communication method of the present invention. FIG. 14 is an illustrative diagram showing a hardware configuration for a radio base station and a user terminal according to one or more embodiments of the present invention. The above-described radio base station 10 and user terminal 20 may each be physically configured as a computer device including a processor 1001, a memory 1002, storage 1003, a communication device 1004, an input device 1005, an output device 1006, and a bus 1007, etc.

Note that in the following explanations, the term “device” may be replaced with “circuit”, “unit”, etc. The hardware configuration of each of the radio base station and the user terminal 20 may be configured to include on or a plurality of each device that is indicated in the drawings, or may be configured without including some of these devices.

Each function in the radio base station 10 and in the user terminal 20 is implemented, upon reading predetermined software (program) that is in hardware such as the processor 1001 or the memory 1002, etc., by the processor 1001 performing calculations, controlling communication via the communication device 1004, and reading-out and/or writing data in the memory 1002 and the storage 1003.

The processor 1001, e.g., controls the entire computer by operating an operating system. The processor 1001 may be configured as a central processing unit (CPU) that includes interfaces with peripheral devices, control devices, arithmetic devices, and registers, etc. For example, the above-described baseband signal processing section 104 (204) and the call processing section 105, etc., may be implemented with the processor 1001.

Furthermore, the processor 1001 reads a program (program code), software modules and data from the storage 1003 and/or the communication device 1004 to the memory 1002, and carries out each type of process accordingly. In regard to the program, a program which performs at least some of the operations described above in a computer is used. For example, the control section 401 of the user terminal 20 may be implemented using a control program that is stored in the memory 1002 and is operated by the processor 1001; other functional blocks may be implemented in the same manner.

The memory 1002 is a computer-readable storage medium and may be configured of at least one of, e.g., ROM (Read Only Memory), EPROM (Erasable Programmable ROM), and RAM (Random Access Memory), etc. The memory 1002 may be referred to as a “register”, “cache”, “main memory” (main memory device), etc. The memory 1002 can store a runnable program (program code) or a software module, etc., in order to implement the radio communication methods pertaining to the embodiments of the present invention.

The storage 1003 is a computer-readable storage medium and may be configured of at least one of, e.g., an optical disk such as a CD-ROM (Compact Disc ROM), etc., a hard disk-drive, a flexible disk, a magnetic optical disk, and flash memory, etc. The storage 1003 may be referred to as an “auxiliary memory device”.

The communication device 1004 is hardware (transmission/reception device) for carrying out communication with a computer via a fixed-line and/or wireless network, and can be referred to as, e.g., a “network device”, a “network controller”, a “network card” or a “communication module”, etc. For example, the above-described transmission/reception antennas 101 (201), the amplifying sections 102 (202), the transmitting/receiving sections 103 (203) and the transmission path interface 106 may be implemented using the communication device 1004.

The input device 1005 is an input device (e.g., a keyboard or mouse, etc.) which receives external input. The output device 1006 is an output device (e.g., display, speaker, etc.) for external output. Note that the input device 1005 and the output device 1006 may be integrally configured (e.g., as a touch panel).

Furthermore, each device, such as the processor 1001 and the memory 1002, etc., are connected to each other by a bus 1007. The bus 1007 may be configured of a single bus or from different buses between the devices.

Furthermore, the radio base station 10 and the user terminal 20 may include hardware such as microprocessors, Application Specific Integrated Circuits (ASICs), Programmable Logic Devices (PLDs) and Field Programmable Gate Arrays (FPGAs), etc., and part or all of the functional blocks may be implemented using such hardware. For example, the processor 1001 may be installed using at least one of the above-mentioned hardware.

Note that technical terms discussed in the present specification and/or technical terms necessary for understanding the present specification may be replaced with technical terms having the same or similar meaning. For example, channel and/or symbol may be signals (signaling). Furthermore, a signal may be a message. Furthermore, component carrier (CC) may be called a frequency carrier, a carrier frequency or cell, etc.

Furthermore, information and parameters, etc., discussed in the present specification may be expressed as absolute values, or as a relative value with respect to a predetermined value, or expressed as other corresponding information. For example, a radio resource may be indicated as an index.

Information and signals, etc., discussed in the present specification may be expressed using any one of various different technologies. For example, data, instructions, commands, information, signals, bits, symbols, chips, etc., that could be referred to throughout the above description may be expressed as voltage, current, electromagnetic waves, a magnetic field or magnetic particles, optical field or photons, or a desired combination thereof.

Furthermore, software, commands and information, etc., may be transmitted and received via a transmission medium. For example, in the case where software is transmitted from a website, server or other remote source by using fixed-line technology (such as coaxial cable, optical fiber cable, twisted-pair wire and digital subscriber's line (DSL), etc.) and/or wireless technology (such as infrared or microwaves, etc.) such fixed-line technology and wireless technology are included within the definition of a transmission medium.

Furthermore, the radio base station described in embodiments of the present invention can be read as a user terminal 20. For example, the configuration in which communication is carried out between the radio base station and the user terminal can be replaced by a configuration in which communication is carried out between a plurality of user terminals (D2D: Device-to-Device) and applied to each aspect/embodiment of the present invention. In such a case, the functions provided in the above-described radio base station 10 may be provided in the user terminal 20. Furthermore, the terms “uplink” and “downlink” may be read as “side-link”. For example, an uplink channel may be read as a side-link channel.

Similarly, the user terminal 20 described in embodiments of the present invention may be read as a radio base station. In such a case, the functions provided in the above-described user terminal 20 may be provided in the radio base station 10.

The above-described aspects/embodiments of the present invention may be used independently, used in combination, or may be used by switching therebetween when being implemented. Furthermore, notification of predetermined information (e.g., notification of “is X”) does not need to be explicit, but may be implicitly (e.g., by not notifying the predetermined information) carried out.

Notification of information is not limited to the aspects/embodiments of the present invention, such notification may be carried out via a different method. For example, notification of information may be implemented by physical layer signaling (e.g., Downlink Control Information (DCI), Uplink Control Information (UCI)), higher layer signaling (e.g., Radio Resource Control (RRC) signaling, broadcast information (Master Information Block (MIB), System Information Block (SIB)), Medium Access Control (MAC) signaling, by other signals or a combination thereof. Furthermore, RRC signaling may be called a “RRC message” and may be, e.g., an RRC connection setup (RRCConnectionSetup) message, or an RRC connection reconfiguration (RRCConnectionReconfiguration) message, etc. Furthermore, MAC signaling may be notified using MAC control elements (MAC CE (Control Elements)).

The above-described aspects/embodiments of the present invention may be applied to a system that utilizes LTE, LTE-A, LTE-B, SUPER 3G, IMT-Advanced, 4G, 5G, FRA, New-RAT, CDMA2000, Ultra Mobile Broadband (UMB), IEEE 802.11 (Wi-Fi®), IEEE 802.16 (WiMAX®), IEEE 802.20, Ultra-WideBand (UWB), Bluetooth ®, or other suitable systems and/or to an enhanced next-generation system that is based on any of these systems.

The order of processes, sequences and flowcharts, etc., in the above-described aspects/embodiments of the present invention can have a switched order so long no contradictions occur. For example, each method described in the present specification proposes an example of an order of various steps but are not limited to the specified order thereof.

Hereinabove, the present invention has been described in detail by use of the foregoing embodiments. However, it is apparent to those skilled in the art that the present invention should not be limited to the embodiment described in the specification. For example, each above-described embodiment may be used individually or used in combination. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

1. A user terminal which carries out communication using a predetermined radio access scheme, said user terminal comprising:
a receiving section configured to receive a reference signal in a specified radio resource, and carry out a reception process on the reference signal based on a specified orthogonalization application range; and
a control section configured to decide the specified radio resource and/or the specified orthogonalization application range based on communication parameters used in the predetermined radio access scheme.

2. The user terminal according to claim 1, wherein the communication parameters include at least one of a sub-carrier spacing, a carrier frequency, a number of symbols configuring a predetermined radio resource region, and a number of sub-carriers configuring a predetermined radio resource region.

3. The user terminal according to claim 1, wherein the control section is configured to decide the specified orthogonalization application range based on the communication parameters and on a number of layers configured in the user terminal.

4. The user terminal according to claim 1, wherein, compared to a reference signal configuration of an existing LTE system, the specified radio resource has a same number of resource elements in the time direction and has a same number of resource elements in the frequency direction.

5. The user terminal according to claim 1, wherein, compared to a reference signal configuration of an existing LTE system, the specified radio resource is different in regard to at least one of a number of resource elements in the time direction and a number of resource elements in the frequency direction.

6. The user terminal according to claim 1, wherein, in at least one layer, the receiving section a code length that is different to another layer is used to carry out the reception process of the reference signal.

7. The user terminal according to claim 1, wherein the receiving section, within a predetermined radio resource region, carries out the reception process while considering at least one code element of an orthogonal code, applied to the reference signal, that overlaps at least one of the reference signal resource elements (REs) of the specified radio resource.

8. A user terminal which carries out communication using a predetermined radio access scheme, said user terminal comprising:
a transmitting section configured to apply orthogonalization to a reference signal based on a specified orthogonalization application range, and transmit the reference signal in a specified radio resource; and
a control section configured to decide the specified radio resource and/or the specified orthogonalization application range based on communication parameters used in the predetermined radio access scheme.

9. A radio base station which carries out communication with a user terminal using a predetermined radio access scheme, said radio base station comprising:
a transmitting section configured to apply orthogonalization to a reference signal based on a specified orthogonalization application range, and transmit the reference signal in a specified radio resource; and
a control section configured to decide the specified radio resource and/or the specified orthogonalization application range based on communication parameters used in the predetermined radio access scheme.

10. (canceled)

11. The user terminal according to claim 2, wherein the control section is configured to decide the specified orthogonalization application range based on the communication parameters and on a number of layers configured in the user terminal.

12. The user terminal according to claim 2, wherein, compared to a reference signal configuration of an existing LTE system, the specified radio resource has a same number of resource elements in the time direction and has a same number of resource elements in the frequency direction.

13. The user terminal according to claim 3, wherein, compared to a reference signal configuration of an existing LTE system, the specified radio resource has a same number of resource elements in the time direction and has a same number of resource elements in the frequency direction.

14. The user terminal according to claim 2, wherein, compared to a reference signal configuration of an existing LTE system, the specified radio resource is different in regard to at least one of a number of resource elements in the time direction and a number of resource elements in the frequency direction.

15. The user terminal according to claim 3, wherein, compared to a reference signal configuration of an existing LTE system, the specified radio resource is different in regard to at least one of a number of resource elements in the time direction and a number of resource elements in the frequency direction.

16. The user terminal according to claim 4, wherein, compared to a reference signal configuration of an existing LTE system, the specified radio resource is different in regard to at least one of a number of resource elements in the time direction and a number of resource elements in the frequency direction.

17. The user terminal according to claim 2, wherein, in at least one layer, the receiving section a code length that is different to another layer is used to carry out the reception process of the reference signal.

18. The user terminal according to claim 3, wherein, in at least one layer, the receiving section a code length that is different to another layer is used to carry out the reception process of the reference signal.

19. The user terminal according to claim 4, wherein, in at least one layer, the receiving section a code length that is different to another layer is used to carry out the reception process of the reference signal.

20. The user terminal according to claim 5, wherein, in at least one layer, the receiving section a code length that is different to another layer is used to carry out the reception process of the reference signal.
